(19) United States
(12) Patent Application Publication
(10) Pub. No.: US 2016/0259194 A1
(43) Pub. Date: Sep. 8, 2016

(54) TOUCH DISPLAY DEVICE

(71) Applicants: Interface Optoelectronics (ShenZhen) Co., Ltd., Shenzhen (CN); General Interface Solution Limited, Miaoli County (TW)

(72) Inventor: Yen-Chang YAO, Guangdong (CN)

(21) Appl. No.: 14/742,718

(22) Filed: Jun. 18, 2015

(30) Foreign Application Priority Data
Mar. 5, 2015 (CN) 201510098999.2

(51) Int. Cl. G02F 1/1333; G06F 3/041

(52) U.S. Cl. CPC G02F 1/13338; G02F 1/133308; G06F 3/0412; G02F 2001/133331

(57) ABSTRACT

A touch display device includes a cover glass, a liquid crystal panel, and at least one reinforcing piece. The cover glass has an active area and a peripheral area surrounding the active area, and the cover glass includes at least one opening. The liquid crystal panel is disposed at the active area. The reinforcing piece is disposed at the peripheral area, and the reinforcing piece includes a reinforcing opening. A projection of the reinforcing piece opening on the cover glass is at least partially overlapped with a projection of the opening.

### RELATED APPLICATIONS

This application claims priority to Chinese Application Serial Number 201510098999.2, filed Mar. 5, 2015, which is herein incorporated by reference.

### BACKGROUND

1. Field of Invention

The present invention relates to a touch display device.

2. Description of Related Art

At recent year, the development of the touch display devices keeps flourishing. Since the touch display devices are often applied in carried product in daily use, in the design, the thinning is a necessary trend in design of the touch display devices for reducing the volume and weight.

In the touch display devices, the outermost cover glass is also designed with a reduced thickness. Although the less thickness can reduce the volume and weight, it also limits the impact-resistant ability of the cover glass. Especially, if the cover glass is configured with a concave structure or a hole structure, the cover glass is more vulnerable due to the concentrated stress at the spot, thereby significantly reducing the lifetime and yield of the products.

### SUMMARY

One embodiment of the present invention provides a touch display device. By the configuring the reinforcing piece with similar shapes to the cover glass, the deformation of the cover glass is limited, and the force withstanding the tension generated by external strike is enhanced, thereby preventing the cover glass from being broken due to the external strike.

According to one embodiment of the present invention, a touch display device including a cover glass, a liquid crystal panel, and at least one reinforcing piece is provided. The cover glass has an active area and a peripheral area surrounding the active area, and the cover glass includes at least one opening. The liquid crystal panel is disposed at the active area. The reinforcing piece is disposed at the peripheral area, and the reinforcing piece includes a reinforcing piece opening. A projection of the reinforcing piece opening on the cover glass is at least partially overlapped with a projection of the opening.

In one or more embodiments of the present invention, the touch display device further includes an adhesive layer disposed between the cover glass and the reinforcing piece.

In one or more embodiments of the present invention, a sidewall of the opening of the cover glass is flush with a sidewall of the reinforcing piece opening.

In one or more embodiments of the present invention, the opening and the reinforcing piece opening are both enclosed type openings.

In one or more embodiments of the present invention, the touch display device further includes a button penetrating the opening and the reinforcing piece opening.

In one or more embodiments of the present invention, the opening and the reinforcing piece opening are both open type openings.

In one or more embodiments of the present invention, the reinforcing piece has a thickness in a range from 0.1 millimeters to 3 millimeters.

In one or more embodiments of the present invention, a rigidity of the reinforcing piece is greater than a rigidity of the cover glass.

In one or more embodiments of the present invention, the number of the reinforcing pieces is plural, and the touch display device further comprises a plurality of adhesive layers to bond the reinforcing pieces.

In one or more embodiments of the present invention, the cover glass is a touch glass.

### BRIEF DESCRIPTION OF THE DRAWINGS

The invention can be more fully understood by reading the following detailed description of the embodiment, with reference made to the accompanying drawings as follows:

FIG. 1 is a perspective view of the touch display device according to one embodiment of the present invention;

FIG. 2 is a cross-sectional view of the touch display device along the line A-A of FIG. 1;

FIG. 3 is a cross-sectional view of the touch display of FIG. 2 when an external force is exerted;

FIG. 4 is a cross-sectional view of the touch display device according to another embodiment of the present invention;

FIG. 5 is a cross-sectional view of the touch display device according to another embodiment of the present invention;

FIG. 6 is a perspective view of the touch display device according to another embodiment of the present invention;

FIG. 7 is a cross-sectional view of the touch display device along the line B-B of FIG. 6; and

FIG. 8 is a cross-sectional view of the touch display device according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

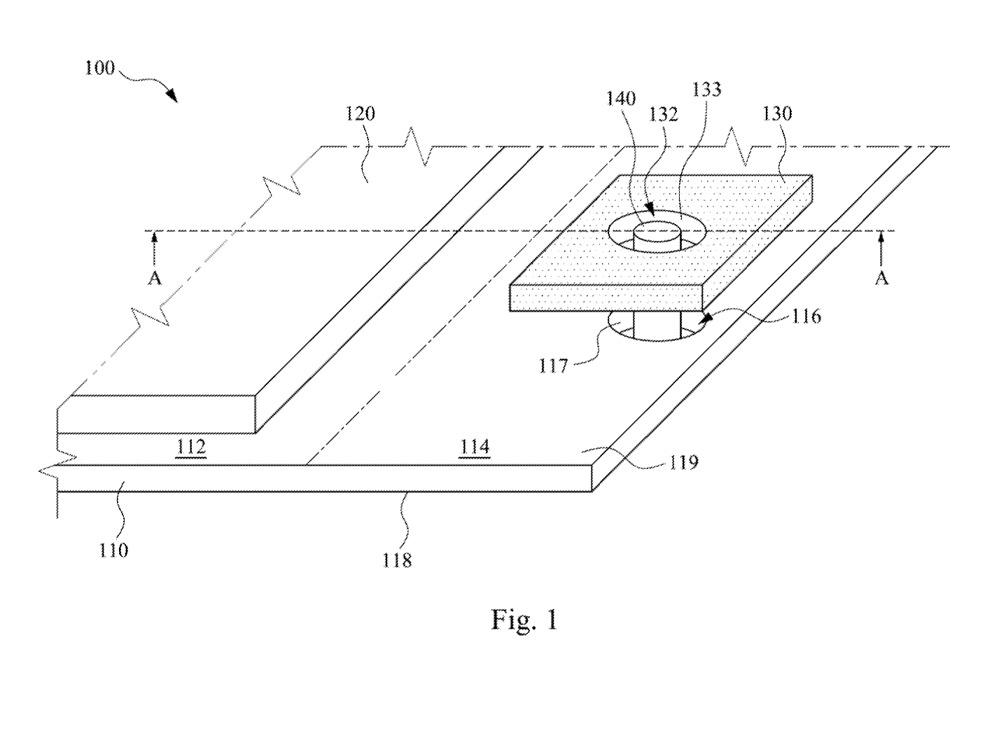

FIG. 1 is a perspective view of the touch display device 100 according to one embodiment of the present invention. The touch display device 100 includes a cover glass 110, a liquid crystal panel 120, and at least one reinforcing piece 130. The cover glass 110 has an active area 112 and a peripheral area 114 surrounding the active area 112. The cover glass 110 can be a touch glass, and the cover glass 110 includes at least one opening 116. The liquid crystal panel 120 is disposed at the active area 112. The reinforcing piece 130 is disposed at the peripheral area 114, and the reinforcing piece 130 includes a reinforcing piece opening 132. A projection of the reinforcing piece opening 132 on the cover glass 110 is at least partially overlapped with a projection of the opening 116.

For better illustrating, plural concepts of the present invention are illustrated by depicting part of the cover glass 110 and the liquid crystal panel 120. Though the whole profile of the cover glass 110 and the liquid crystal panel 120 is not depicted, it should not limit the scope of the present invention. In addition, for perceiving the opening 116, the reinforcing piece 130 is not depicted to be connected or attached to the cover glass 110, but in fact, the reinforcing piece 130 should be attached to the cover glass 110.

In one or more embodiments of the present invention, the opening 116 is disposed at the peripheral area 114, and does not obstruct the users from receiving the displaying information of the touch display device 100. For preventing the reinforcing piece 130 from affecting users in receiving the displaying information of the touch display device 100, and for disposing the opening 116 corresponding to the reinforcing piece opening 132, the reinforcing piece 130 is also disposed at the peripheral area 114.

In this embodiment, the cover glass 110 includes a surface 118 and a surface 119 opposite the surface 118. The surface 118 of the cover glass 110 is disposed facing the users, and the liquid crystal panel 120 and the reinforcing piece 130 are disposed near the surface 119 of the cover glass 110. The opening 116 connects the surface 118 and the surface 119. The users can observe or touch the opening 116 through the surface 118.

In one or more embodiments of the present invention, the opening 116 and the reinforcing piece opening 132 are both enclosed type openings. To be specific, the opening 116 can include a sidewall 117, and the sidewall 117 can be circled to form a space inside. The reinforcing piece opening 132 can include a sidewall 133, and the sidewall 133 can be circled and form a space inside. In this embodiments, the center of the opening 116 is disposed corresponding to the center of the reinforcing piece opening 132. Furthermore, the sidewall 117 of the cover glass 110 is disposed to be flush with the sidewall 133 of the reinforcing piece 130.

There is a wide range of applications for the disposition of the enclosed type opening. For example, the opening can be configured with a loudspeaker to play a sound, or with a detector or camera to receive a sound or light. On the other hand, the opening can be applied for the deposition of a button, the connection of connectors, receiving antenna, beauty purpose, and so on. In this embodiment, merely takes the disposing the button as an example.

The touch display device 110 further includes a button 140 penetrating the opening 116 and the reinforcing piece opening 132. An end of the button 140 is connected to a sensor (not shown) of the touch display device 100. The users can exert a force on another end of the button 140 on the surface 118. The sensor of the touch display device 100 would receive the message of the pressing and transfer the information.

It is worthy to know that the disposing the button 140 is not necessary. As previously description, when the opening 116 is only applied to receiving a sound or light or other purposes, there can be no element inside the opening 116.

Herein, although the shapes of the opening 116 and the reinforcing piece opening 132 are both circles, it should not limit the scope of the present invention. The opening 116 and the reinforcing piece opening 132 can be square, ellipse, triangle, and so on. The shapes of the opening 116 and the reinforcing piece opening 132 can be designed and set based on the actual requirements or the button 140.

In one or more embodiments of the present invention, the materials of the reinforcing piece 130 can be stainless steel, strengthened glass, titanium alloy, liquid metals, other strengthened materials or materials with high rigidity. Ideally, a rigidity of the reinforcing piece 130 is greater than a rigidity of the cover glass 110.

In one or more embodiments of the present invention, the reinforcing piece 130 has a thickness in a range from 0.1 millimeters to 3 millimeters, but it should not limit the scope of the present invention. In one or more embodiment of the present invention, the thickness of the reinforcing piece 130 can be designed to be smaller than or equal to the thickness of the liquid crystal panel 120 for preventing the reinforcing piece 130 from occupying the space of other elements of the display device 100.

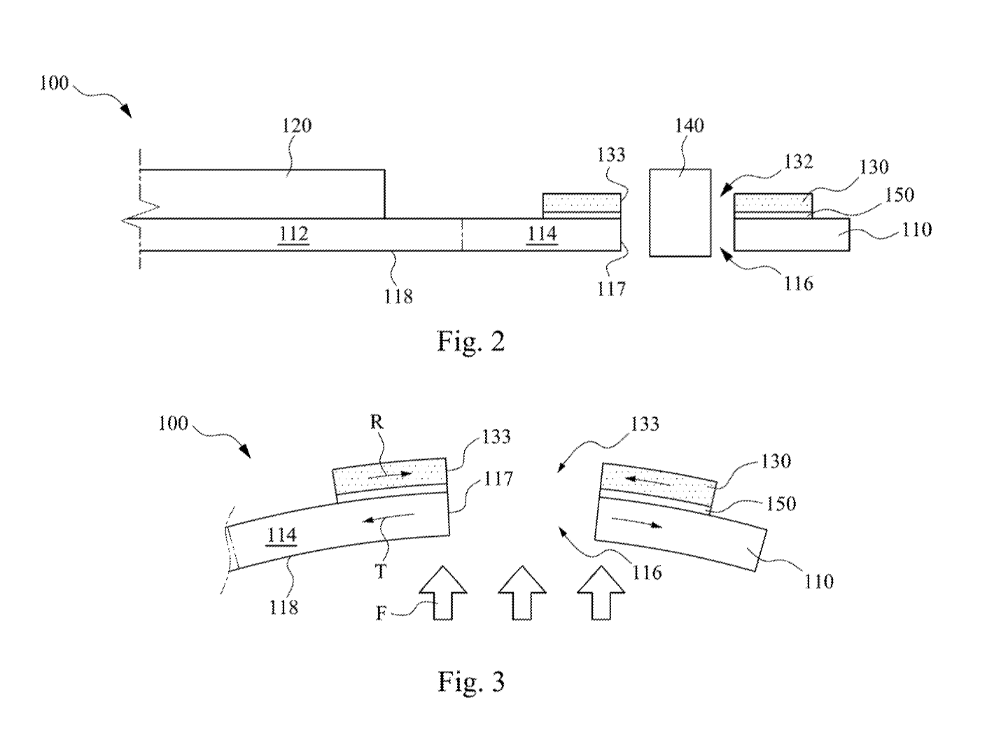

FIG. 2 is a cross-sectional view of the touch display device 100 along the line A-A of FIG. 1. The touch display device 100 can further include an adhesive layer 150. The materials of the adhesive layer 150 can be adhesive gels or adhesive tap. The adhesive layer 150 is disposed between the cover glass 110 and the reinforcing piece 130 for fixing the reinforcing piece 130 on the cover glass 110. The adhesive layer 150 is also disposed in the peripheral area 114 and does not obstruct the users from observing the displaying information.

FIG. 3 is a cross-sectional view of the touch display 100 of FIG. 2 when an external force F is exerted. For better illustrating, the button and the liquid crystal module are not depicted in FIG. 3. As previous description, the disposition of the button can be omitted.

The outermost portion of the touch display device 100 is the surface 118 of the cover glass 110. When the touch display device 100 is hit, the strike forms an external force F exerted on the surface 118. The force F produces a pressure on the surface 118. Generally, for the sake of the opening 116, the region near the opening 116 has smaller area to accept the external force F, and thereto often cause a great pressure. In this way, the portion of the cover glass 118 adjoining the opening 116 often deforms seriously.

When the cover glass 110 deforms under the pressure of the external force, a tension T moving outwards is built inside the cover glass 110. In this embodiment, the reinforcing piece 130, which has a greater rigidity and therefore less easy to deforms, is attached to the cover glass 110. Comparing to the cover glass 110 deforming due to the external force F, the reinforcing piece 130 connected to the cover glass 110 tends not to deform and therefore produces an action force R, which has an acting direction opposite that of the tension T. The action force R suppresses the tension T from increasing.

In other words, the reinforcing piece 130 stops the deformation of the cover glass 110, and suppresses the tension T from increasing. In this way, it is prevented that the tension T increases continually to exceed the elastic limit, so as to result an unrecoverable deformation.

In addition, when the force is exerted, since the adhesive layer 150 is attached to the reinforcing piece 130 and the cover glass 110, the adhesive layer 150 would bend or deform as the reinforcing piece 130 does.

In this embodiment, a flush configuration of the sidewall 117 and the sidewall 133 can help the reinforcing piece 130 withstand the increasing of the tension T of the cover glass 110 effectively. On one hand, the flush configuration can maximize the bonding area between the reinforcing piece 130 and the cover glass 110, and enhance the ability of the reinforcing piece 130 to limit the bend or deformation of the cover glass 110 by increasing the bonding area. On the other hand, the flush configuration can make the reinforcing piece 130 and the cover glass 110 accept the force uniformly. When the strike hit a certain place, the reinforcing piece 130 and the cover glass 110 at the place can both absorb the strike, and then bend or deform. However, it should be understood that the scope of the present invention should not be limited to the flush configuration.

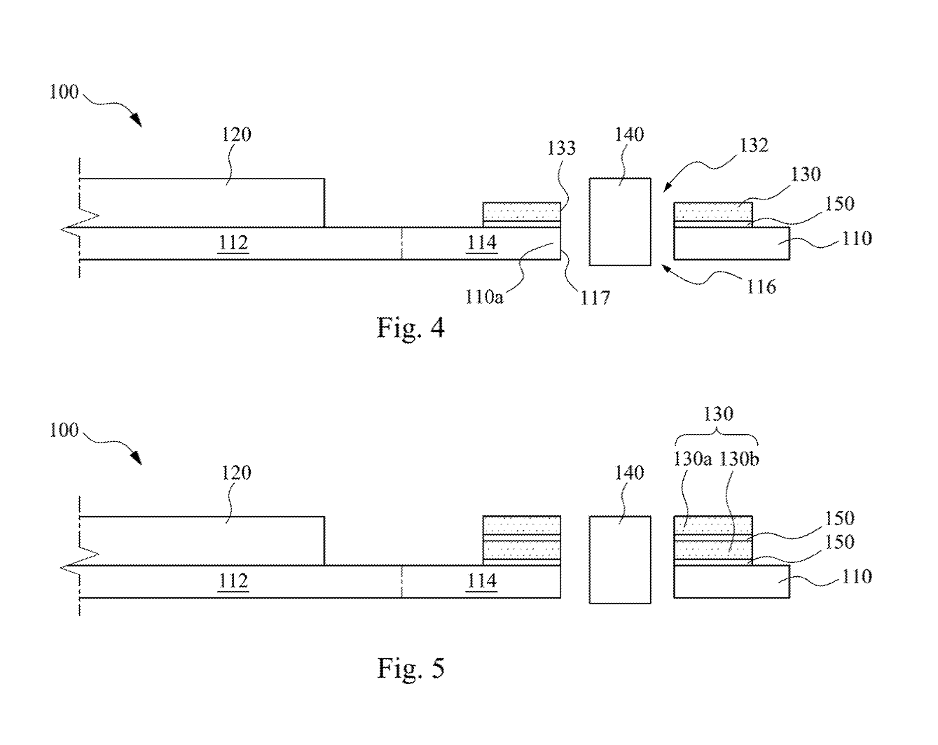

FIG. 4 is a cross-sectional view of the touch display device 100 according to another embodiment of the present invention. This embodiment is substantially similar to the embodiments of FIG. 1 and FIG. 2, and the difference is that: in this embodiment, the projection of the sidewall 133 on the cover glass 110 is not overlapped with the sidewall 117 and the reinforcing opening 132. To be specific, the cover glass 110 has a protruding portion 110a, which protrudes and is not aligned with the reinforcing piece 130, and therefore the sidewall 117 is not flush with the sidewall 133.

In this embodiment, the size of the reinforcing opening 132 is slightly larger than the size of the opening 116. Due to accuracy limitation in the fabrication process, it is not easy to make the size of the reinforcing opening 132 totally equal to the size of the opening 116, and therefore it is fine to configure the size of the reinforcing opening 132 to be slightly larger than the size of the opening 116. It should be noted that, the center of the reinforcing opening 132 is still corresponding to the center of the opening 116.

In this embodiment, when a strike focusedly hits the protruding portion 110a of the cover glass 110, the impact is only absorbed by the protruding portion 110a and make the whole cover glass 110 bend or deform, and then the reinforcing piece 130 limits the deformation or bend of the other portions of the cover glass 110. Since the protruding portion 110a of the cover glass 110 is not configured with the reinforcing piece 130, the degree of deformation or bend thereof is more serious, and it is necessary to arrange the cover glass 110 with the reinforcing piece 130 having high rigidity for limiting the deformation or bend of the whole cover glass 110.

Considering the accuracy problems in the actual fabrication process, it is easier to apply this embodiment to the actual fabrication process. Other details are roughly similar to the embodiment of FIG. 1, and thereto not repeated herein.

FIG. 5 is a cross-sectional view of the touch display device 100 according to another embodiment of the present invention. This embodiment is substantially similar to the embodiments of FIG. 1, and the difference is that: in this embodiment, the number of the reinforcing pieces 130 is plural, and the touch display device 100 further includes plural adhesive layers 150 to bond the reinforcing pieces 130.

In this embodiment, the materials of the reinforcing pieces 130 can be different. For example, the reinforcing pieces 130a can be made of stainless steel, and the reinforcing pieces 130b can be made of titanium alloy. Comparing to the configuration of the single reinforcing piece 130, in this embodiment, by increasing the sum thickness of the reinforcing pieces 130, the ability to withstand the deformation of the reinforcing pieces 130 is increased. On the other hand, assembling the plural reinforcing pieces 130 can achieve the predetermined rigidity, thereby reducing the cost of materials.

Other relevant details are roughly similar to the embodiment of FIG. 1 and FIG. 2, and thereto not repeated herein.

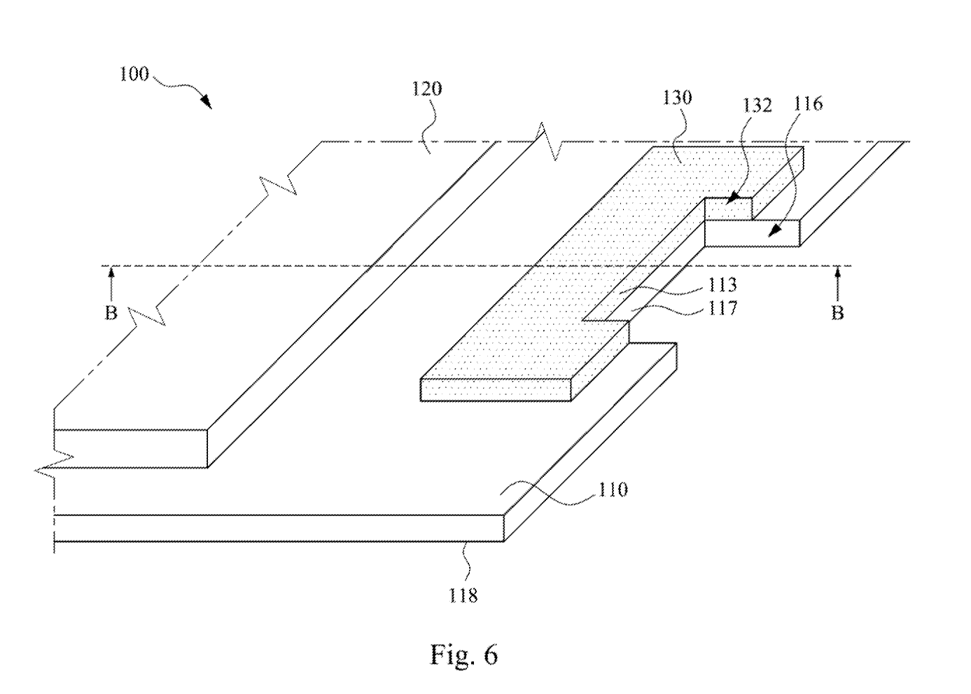

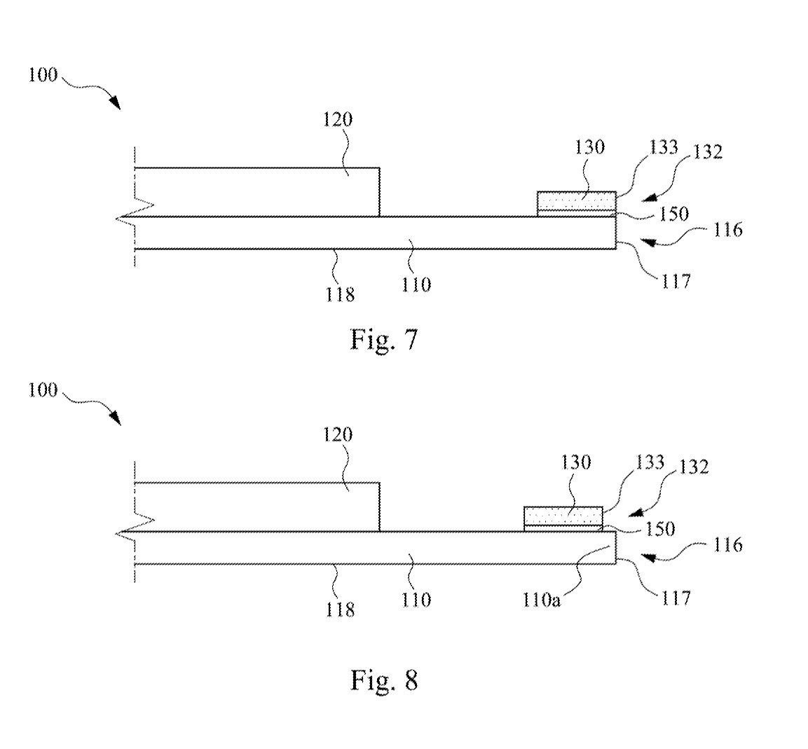

Reference is both made to FIG. 6 and FIG. 7. FIG. 6 is a perspective view of the touch display device 100 according to another embodiment of the present invention. FIG. 7 is a cross-sectional view of the touch display device 100 along the line B-B of FIG. 6. This embodiment is substantially similar to the embodiments of FIG. 1, and the difference is that: in this embodiment, the opening 116 and the reinforcing piece opening 132 are open type openings. The open type openings means that the opening 116 or the reinforcing opening 132 are not surrounded and enclosed by the materials of the cover glass 110 or the reinforcing piece 130. The opening 116 and the reinforcing piece opening 132 are connected with the outer space.

Furthermore, the open type opening makes the reinforcing piece 130 and the cover glass 110 have a concave structure, which protrudes in two end and contracts inwards in middle. Herein, the concave structures of the reinforcing piece 130 and the cover glass 110 are substantially the same, and the projection of the reinforcing piece opening 132 of the reinforcing piece 130 on the cover glass 110 is at least partially overlapped with the projection of the opening 116 of the cover glass 110.

The configuration of the open type opening can be applied in many ways. For example, the opening can help the user hold the device, enhance beauty, help the mechanical assembly, receive sound, receive antenna, and so on.

In this embodiment, though the shapes of the opening 116 and the reinforcing piece opening 132 are both rectangles, but it should not limit the scope of the present invention. The opening 116 and the reinforcing piece opening 132 can include shapes of semi-circle, semi-ellipse, trapezoid, triangle, or the configurations. The shapes of the opening 116 and the reinforcing piece opening 132 can be disposed in accordance with the actual requirement.

As previous description, in this embodiment, the sidewall 117 of the cover glass 110 is flush with the sidewall 133 of the reinforcing piece 130. With this flush configuration, the adhesive area between the reinforcing piece 130 and the cover glass 110 can be increased, the reinforcing piece 130 and the cover glass 110 can accept the external force uniformly and thus decrease the impact, and users are prevented from observing the reinforcing piece 130 from the surface 118.

As previous description, when the force is exerted on the surface 118, the cover glass 110 bends or deforms and generates the tension. At this time, the reinforcing piece 130 attached to the cover glass 110 has a greater rigidity and deformation resistance, and thus is capable of constraining the bend or deformation of the cover glass 110 with the attached reinforcing piece 130. As such, the increase in the tension of the cover glass 110 is prevented.

Other relevant details are roughly similar to the embodiments of FIG. 1 and FIG. 2, and thereto not repeated herein.

FIG. 8 is a cross-sectional view of the touch display device 100 according to another embodiment of the present invention. This embodiment is substantially similar to the embodiments of FIG. 6 and FIG. 7, and the difference is that: in this embodiment, the projection of the sidewall 133 on the cover glass 110 is not overlapped with the sidewall 117 and the reinforcing opening 132. To be specific, the cover glass 110 has the protruding portion 110a, which protrudes and is not aligned with the reinforcing piece 130, and therefore the sidewall 117 is not flush with the sidewall 133.

As previous description, due to the limited accuracy in the fabrication process, it is not easy to align the sidewall 117 with the sidewall 133 precisely. Therefore, the sidewall 133 can be designed to be slightly inwards, preventing the sidewall 133 from being exposed by the opening 116. In this way, users are prevented from observing the reinforcing piece 130 from the surface 118. When the touch display device 100 is hit, the reinforcing piece 130 can still limit the bend or deformation of the cover glass 110.

In this embodiment, when a strike is centralized and hit the protruding portion 110a of the cover glass 110, the strike is only absorbed by the protruding portion 110a, the whole cover glass 110 bends or deforms, and then the reinforcing piece 130 limits the deformation or bend of the other portions of the cover glass 110. Since the protruding portion 110a of the cover glass 110 is not configured with the reinforcing piece 130, the degree of deformation or bend thereof is more serious, and it may be necessary to arrange the cover glass 110 with the reinforcing piece 130 having high rigidity for limiting the deformation or the bend of the whole cover glass 110.

Considering the accuracy problems in the actual fabrication process, it is easier to apply the concepts of this embodiment to the actual fabrication process. Other details are roughly similar to the embodiments of FIG. 6 and FIG. 7, and thereto not repeated herein.

One embodiment of the present invention provides a touch display device. The reinforcing piece is configured to include a shape similar to the cover glass, so that the reinforcing piece can withstand the tension generated by external strike, thereby preventing the cover glass from being broken due to the external strike.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A touch display device, comprising:
a cover glass comprising an active region and a peripheral region surrounding the active region, the cover glass comprising at least one opening;
a liquid crystal panel disposed at the active region;
at least one reinforcing piece disposed at the peripheral region, the reinforcing piece comprising an reinforcing piece opening, wherein a projection of the reinforcing piece opening on the cover glass is at least partially overlapped with a projection of the opening on the cover glass; and
a button present in the opening and the reinforcing piece opening, wherein a first element of the button present in the opening and a second element of the button present in the reinforcing piece opening are physically connected.

2. The touch display device of claim 1, further comprising an adhesive layer disposed between the cover glass and the reinforcing piece.

3. The touch display device of claim 1, wherein a sidewall of the opening of the cover glass is flush with a sidewall of the reinforcing piece opening.

4. The touch display device of claim 3, wherein the opening and the reinforcing piece opening are both enclosed type openings.

5. (canceled)

6. The touch display device of claim 1, wherein the opening and the reinforcing piece opening are both open type openings.

7. The touch display device of claim 1, wherein the reinforcing piece has a thickness in a range from 0.1 millimeters to 3 millimeters.

8. The touch display device of claim 1, wherein a rigidity of the reinforcing piece is greater than a rigidity of the cover glass.

9. The touch display device of claim 1, wherein the number of the reinforcing pieces is plural, and the touch display device further comprises a plurality of adhesive layers to bond the reinforcing pieces.

10. The touch display device of claim 1, wherein the cover glass is a touch glass.

11. The touch display device of claim 1, wherein a projection of the reinforcing piece on the cover glass is separated from a projection of the liquid crystal panel on the cover glass.
